(19) United States
(12) Patent Application Publication
(10) Pub. No.: US 2003/0040330 A1
(43) Pub. Date: Feb. 27, 2003

(54) Foldable wireless terminal

(75) Inventors: Ki-Hyun Kim, Suwon-shi (KR); Hyun-Myung Song, Seoul (KR)

Correspondence Address: PAUL J. FARRELL, ESQ., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/219,179

(22) Filed: Aug. 15, 2002

(30) Foreign Application Priority Data
Aug. 23, 2001 (KR) P2001/51182

(51) Int. Cl. H04M 1/00

(52) U.S. Cl. 455/550; 455/575

(57) ABSTRACT

A foldable, portable wireless terminal is provided, which comprises a main body; a sub-body capable of folding and unfolding with respect to the main body; and an opening/closing device for automatically or manually opening or closing the sub-body with respect to the main body by user selection. The opening/closing device includes a hinge cam with an end fixed to the main body or the sub-body, a deceleration module adapted to move axially and including an integrally formed hinge shaft, the hinge shaft adapted for selectively rotating the hinge cam in an automatic mode through rotation of a driving motor, an elastic member for biasing the deceleration module axially, and a hollow hinge arm for enclosing the hinge cam, the deceleration module, and the elastic member in series, the hinge arm being mounted to the main body or the sub-body to act as a hinge module.

### PRIORITY

This application claims priority to an application entitled “Foldable, Portable Wireless Terminal for Automatic and Manual Use” filed in the Korean Industrial Property Office on Aug. 23, 2001 and assigned Serial No. 2001-51182, the contents of which are hereby incorporated by reference.

### BACKGROUND OF THE INVENTION

1. Field of the Invention

The present invention relates generally to a portable wireless terminal or radiotelephone having a sub-body that can be opened or closed automatically or manually with respect to a main body, and in particular, to a foldable, portable wireless terminal for automatic and manual use that has a deceleration module so configured as to facilitate assembly and reduce production cost.

2. Description of the Related Art

A foldable, portable wireless terminal is a terminal having a sub-body that can be opened or closed with respect to a main body. Such foldable mobile terminals include a flip cover type, a folder type, and a flip-up type.

A portable wireless terminal having a sub-body that can be opened or closed with respect to a main body manually or automatically (electrically) using a driving device has been recently provided together with various efforts to make such portable wireless terminals smaller, thinner and lighter.

In order to meet such user demands, Korea Patent Application No. 1999-27131, which was filed on Jul. 6, 1999 and commonly assigned to the Assignee of this application, proposed a foldable terminal having a sub-body automatically (electrically) opened or closed with respect to a main body by simple switching. The operation of the sub-body only by an automatic operation, however, increases power consumption and may cause loose closing of the sub-body to the main body. Consequently, a variety of user demands cannot be satisfied.

To further satisfy user demands, Korea Patent Application No. 1999-49228, which was filed on Nov. 8, 1999 and commonly assigned to the Assignee of this application, proposed an improved wireless terminal which is capable of folding manually and automatically. This wireless terminal has a hinge shaft rotatable by a deceleration module, a hinge cam rotatable by the hinge shaft, and a hollow hinge arm for enclosing the deceleration module, the hinge shaft, and the hinge cam in series. Here, in a manual mode, the hinge shaft is retractable only in an axial direction while rotating together with the hinge arm. That is, the hinge shaft mounted to a driving shaft of the deceleration module can rotate by rotation of the driving shaft only in an automatic mode, but it cannot rotate in the manual mode. The deceleration module includes a combination of gear rings that decrease the rotation speed of a driving motor and increase its rotating force, thereby enabling automatic opening and closing of a sub-body with respect to a main body However, since the gear rings are formed of a metal, its operation is not smooth and makes noise.

For the purpose of eliminating noise and achieving smoother operation, Korea Patent Application No. 2000-87216, which was filed on Dec. 30, 2000 and commonly assigned to the Assignee of this application, proposed a plastic guide gear for guiding a plurality of metal spur gears. However, the spur gears in a deceleration module still make noise since they are metal. Moreover, use of many components involved renders the assembly process lengthy and complicated, resulting in increase of production cost.

### SUMMARY OF THE INVENTION

It is, therefore, an object of the present invention to provide an automatically and manually foldable, portable wireless terminal having a hinge shaft integrally formed with components of a deceleration module in order to reduce the number of components and thus production cost.

It is another object of the present invention to provide an automatically and manually foldable, portable wireless terminal having a hinge shaft integrally formed with components of a deceleration module out of plastic material and thus to reduce production cost but to increase productivity in the manufacturing process.

The foregoing and other objects of the present invention are achieved by providing a foldable, portable wireless terminal capable of folding/unfolding automatically and manually, which includes: a main body; a sub-body capable of folding and unfolding with respect to the main body; and an opening/closing device for automatically or manually opening or closing the sub-body with respect to the main body by user selection. The opening/closing device includes a hinge cam with an end fixed to the main body or the sub-body, and a deceleration module adapted to move axially and including an integrally formed hinge shaft, the hinge shaft adapted for selectively rotating the hinge cam in an automatic mode through rotation of a driving motor. Also provided are an elastic member for biasing the deceleration module axially and a hollow hinge arm for enclosing the hinge cam, the deceleration module and the elastic member in series, the hinge arm being mounted to the main body or the sub-body to act as a hinge module.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of a portable wireless terminal that can be folded automatically and manually;

FIG. 2 is a partial sectional view of a portable wireless terminal having an opening/closing device installed in a hinge arm according to a preferred embodiment of the present invention;

FIG. 3 is an exploded perspective view of the opening/closing device according to the preferred embodiment of the present invention;

FIG. 4 is an exploded perspective view of a deceleration module of the opening/closing device according to the preferred embodiment of the present invention;

FIG. 5 is a partial sectional view of a module housing for the deceleration module according to the preferred embodiment of the present invention;

FIG. 6 is a perspective view of a rotator of the deceleration module according to the preferred embodiment of the present invention;

FIG. 7 is a partial sectional view of the deceleration module according to the preferred embodiment of the present invention; and

FIG. 8 is a sectional view of the deceleration module shown in FIG. 7, taken along line A-A′.

### DETAILED DESCRIPTION OF THE PREFERRED EMBODIMENT

A preferred embodiment of the present invention will be described hereinbelow with reference to the accompanying drawings. In the following description, well-known functions or constructions are not described in detail since they would obscure the invention in unnecessary detail.

The present invention provides a portable terminal having a sub-body mounted on a main body such that the sub-body can be placed in an open/closed state with respect to the main body automatically (electrically) or manually. While an opening/closing device according to the present invention is described hereinbelow in the context of a folder-type portable terminal, it will be obvious to those skilled in the art that the opening/closing device is also applicable to other foldable portable terminals such as a flip-up type and a flip type.

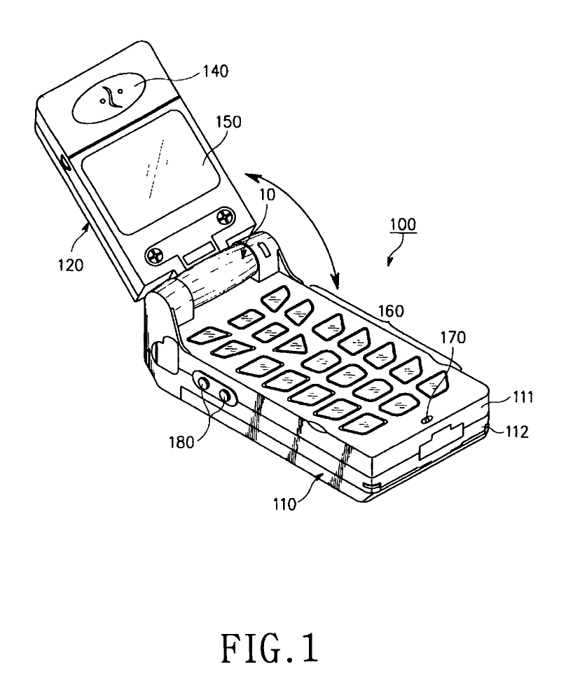

FIG. 1 is a perspective view of an automatically and manually foldable, portable wireless terminal. Referring to FIG. 1, the terminal 100 includes a main body 110 having an upper casing frame 111 and a lower casing frame 112, a sub-body 120 mounted to the main body 110 such that it can be opened or closed from/to the main body 110 automatically or manually by user selection, and an opening/closing device 10 for opening and closing the sub-body 120 with respect to the main body 110.

The main body 110 preferably includes an antenna (not shown) installed at an uppermost end of the main body 110. An earpiece 140 is located at the sub-body 120 and an LCD (Liquid Crystal Display) module 150 is disposed below the earpiece 140 to display relevant information. A keypad 160 is disposed on the main body 110 for the user to input data and a microphone 170 is disposed under the keypad 160. Buttons 180 are provided on a side of the main body 110 to automatically open or close the sub-body 120 with respect to the main body 110. A hinge module is used in the terminal 100 to connect the main body 110 and the sub-body 120. The opening/closing device 10 functions to open and/or close the sub-body automatically or manually as well as working as a hinge arm.

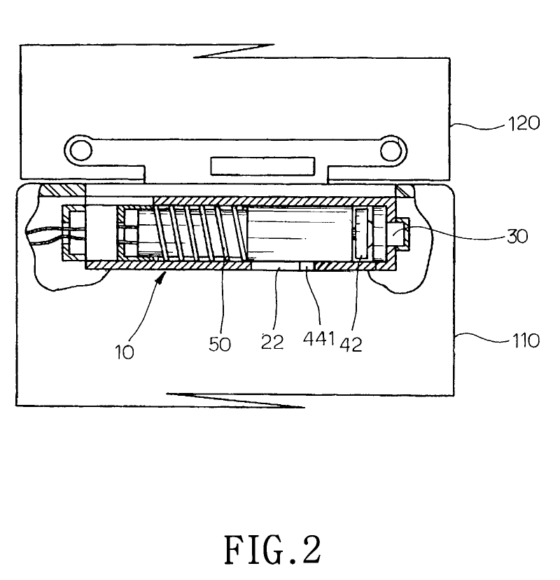

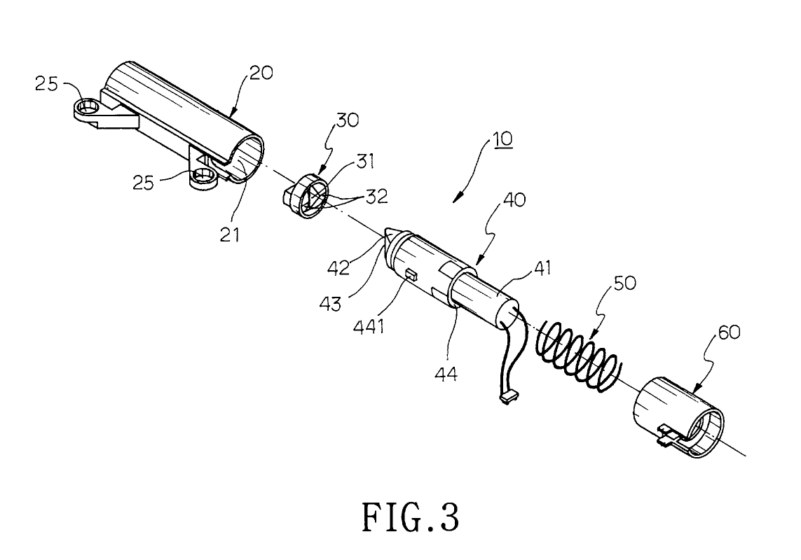

Referring now to FIGS. 2 and 3, FIG. 2 is a partial sectional view of the portable wireless terminal having the opening/closing device installed in a hinge arm according to a preferred embodiment of the present invention, and FIG. 3 is an exploded perspective view of the opening/closing device. The opening/closing device 10 includes a hinge cam 30 having one end mounted to the main body or the sub-body, a deceleration module 40 moveable only axially and having an end integrally formed with a hinge shaft 42 which is selectively rotatable in conjunction with the hinge cam 30 in an automatic or manual mode and the other end provided with a driving motor 41 for rotating the hinge shaft 42. The opening/closing device 10 further includes an elastic member 50 for biasing the deceleration module 40 axially, and a hollow hinge arm 20 fixed as a hinge module to the sub-body or the main body, for enclosing the hinge cam 30, the deceleration module 40, and the elastic member 50 in series.

The hinge arm 20 connects the main body to the sub-body and functions as a housing for the hinge cam 30 and the deceleration module 40 having the hinge shaft 42. Thus, no separate hinge housing is necessary in addition to the hinge arm 20.

The hinge cam 30 has a pair of peak portions 32 and a valley portion 31 defined between the peak portions 32 on the inner surface facing the hinge shaft 42. The outer surface of the hinge cam 30 partially protrudes from the hinge arm 20 and is mounted to the main body

A protrusion 43 of a particular shape is formed on the surface of the hinge shaft 42 facing the hinge cam 30 for fitting with the valley portion 31 of the hinge cam. In an automatic mode, as the hinge shaft 42 rotates by rotation of the deceleration module 40, the protrusion 43 is caught between the peak portions 32 of the hinge cam 30, to thereby rotate the sub-body to an opening or closing position. That is, in an automatic mode, the protrusion 43 of the hinge shaft 42 is caught between the peak portions 32 of the hinge cam 30 and as a result, the hinge cam 30 rotates together with the hinge shaft 42. In a manual mode, the peak portions 32 of the hinge cam 30 push the protrusion 43 of the hinge, so that the deceleration module 40 retreats in the axial direction. A compressed coil spring can be used as the elastic member 50 for pressing the deceleration module 40 in the axial direction.

A hollow spacer 60 is inserted into a central cavity 21 of the hinge arm 20 to support one end of the elastic member 50 and a hollow hinge dummy (not shown) can be inserted into the spacer 60. One end of the compressed coil spring 50 disposed between the hinge dummy and the deceleration module 40 is supported by the spacer 60 as stated above and the other end thereof is supported by a step portion 44 defined on the outer circumferential surface of the deceleration module 40.

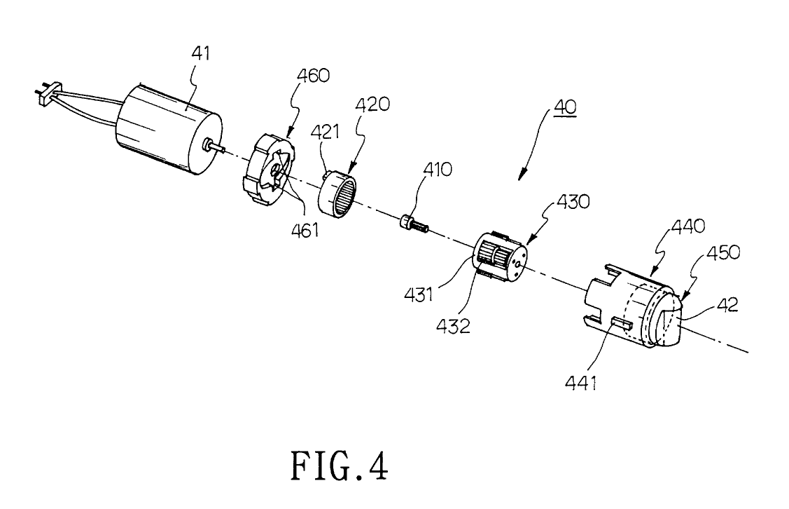

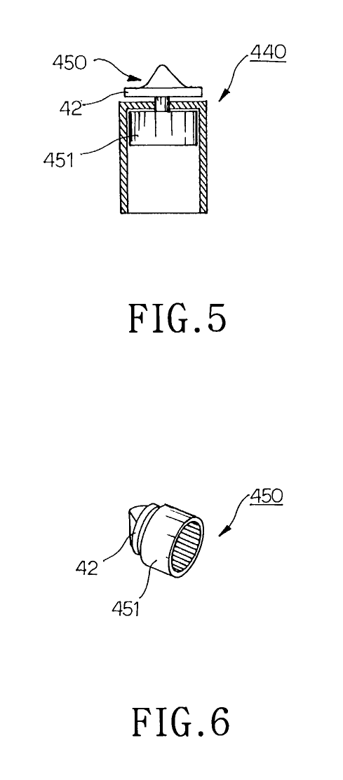

FIG. 4 is an exploded perspective view of the deceleration module of the opening/closing device, FIG. 5 is a partial sectional view of a module housing for the deceleration module, and FIG. 6 is a perspective view of a rotator in the deceleration module according to the preferred embodiment of the present invention. Referring to FIGS. 4, 5 and 6, the deceleration module 40 includes a driving motor 41 with a spur gear 410 mounted on its driving axis, a hollow guide gear 420 having teeth on the inner circumferential surface thereof and fixed on the driving motor 41 with the spur gear 410 inserted into the hollow guide gear 420, and a gear module 430 that has a cylindrical box 431 with at least two spur gears 432 and is partially inserted into the guide gear 420 in teeth-engagement with the guide gear 420 and the spur gear 410. The deceleration module 40 further includes a rotator 450 having a rotating gear 451 with its teeth on the inner circumferential surface thereof to transfer rotational force by teeth-engagement with the spur gears 432, hinge shaft 42 integrally formed with the rotating gear 451, and module housing 440 having an end fixed to the driving motor 41, for housing the guide gear 420 and the gear module 430 such that the gear module 430 is rotatable within the rotating gear 451 of the rotator 450.

At least two spur gears 432, preferably three spur gears 432, are installed in the gear module 430, and the cylindrical box 431 and the spur gears 432 can be preferably formed out of plastic, for example, by injection molding. In order to permit movement of the deceleration module 430 only in the axial direction within the hinge arm 20, a protrusion 441 is formed in an appropriate position on the outer circumferential surface of the module housing 440 and a guide slit 22 (shown in FIG. 2) is formed on the inner circumferential surface of the hinge arm 20 for guiding the protrusion 441 only in the axial direction. The guide gear 420 and the module housing 440 can be connected to a bracket 460 which is in turn mounted on the driving motor 41. Here, the module housing 440 is connected to the bracket 460 preferably by a snap-fit structure.

At least one protrusion 421 is disposed at a location in the guide gear 420 to fit into at least one recess 461 of the bracket 460 to prevent the rotation of the guide gear 420 on the bracket 460. Accordingly, the gear module 430 which is partially inserted into the guide gear 420, can rotate along the inner circumference of the guide gear 420. On the contrary, protrusions 421 can be formed on the bracket 460 and recesses 461 can be formed on the guide gear 420.

Referring to FIGS. 5 and 6, the module housing 440 and the rotator 450 are preferably formed of plastic, for example, by injection molding. The rotator 450 is rotatably mounted on the module housing 440 and can be made by injection molding together with the module housing 440. The rotating gear 451 of the rotator 450 is fit into the module housing 440 through the inner cavity of the module housing 440 such that it is rotatably engaged with parts of the gear module 430. The hinge shaft 42 is disposed outside the module housing 440 to interact with the hinge cam 30.

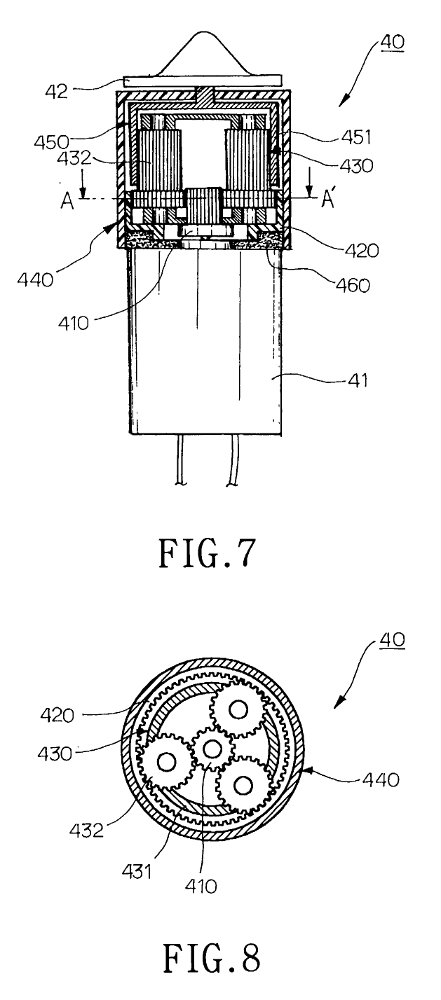

FIG. 7 is a partially sectional view of the deceleration module according to the preferred embodiment of the present invention and FIG. 8 is a sectional plan view of the deceleration module shown in FIG. 7, taken along line A-A′. Referring to FIGS. 7 and 8, the spur gear 410 mounted on a driving shaft of the driving motor 41 is located between the spur gears 432 of the gear module 430. As a result, the multiple spur gears 432 of the gear module 430 rotate simultaneously with rotation of the spur gear 410 attached to the driving motor 41. Since the gear module 430 has its teeth engaged with the inner circumferential surface of the guide gear 420, the cylindrical box 43 1 rotates simultaneously with rotation of the spur gears 432. As the gear module 430 rotates along the inner circumference of the guide gear 420, its rotating speed decreases but its rotating force increases. The rotation of the gear module 430 causes rotation of the rotator 450 installed within the module housing 440 because a portion of the gear module 430 is teeth-engaged with the guide gear 420 and another portion of the gear module 430 is teeth-engaged with the rotating gear 451 of the rotator 450. It is noted that the guide gear 420 is spaced apart from the rotating gear 451, and it prevents interference between the guide gear 420 which is stationary and the rotating gear 451 which is rotatable. When the rotating gear 451 of the rotator 450 rotates, the hinge shaft 42 integrally formed with the rotator 451 rotates together and thereby causing the hinge cam 30 (shown in FIG. 3) to rotate in association therewith. Rotation of the hinge cam 30 opens or closes the sub-body 120 from/to the main body. It is noted that the wireless terminal of the present invention includes a deceleration module of which some components (e.g., rotator 450) are integrally formed with the hinge shaft 42, preferably, by injection molding. Therefore, the number of parts, the number of assembly steps, and production cost can be reduced.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A foldable wireless terminal comprising:
a main body;
a sub-body capable of folding and unfolding with respect to the main body; and
an opening/closing device for automatically or manually opening or closing the sub-body with respect to the main body by user selection, the opening/closing device including a hinge cam which has an end fixed to the main body or the sub-body, a deceleration module axially moveable and including an integrally formed hinge shaft, the hinge shaft selectively rotating the hinge cam in an automatic mode through rotation of a driving motor, an elastic member for biasing the deceleration module axially, and a hollow hinge arm for enclosing the hinge cam, the deceleration module, and the elastic member in series, the hinge arm being mounted to the main body or the sub-body to act as a hinge module

2. The foldable wireless terminal of claim 1, wherein the deceleration module comprises:
the driving motor having a spur gear mounted on a driving shaft;
a hollow guide gear mounted onto the driving motor with the spur gear of the driving motor inserted thereinto and having teeth on the inner circumferential surface thereof;
a gear module having at least two rotatable spur gears in a single cylindrical box and being partially inserted into the guide gear in teeth-engagement with the guide gear and the spur gear of the driving motor;
a rotator having a rotating gear that has teeth on the inner circumferential surface thereof to receive a force in teeth-engagement with the spur gears of the gear module, and the hinge shaft integrally formed with the rotating gear; and
a module housing having an end fixed to the driving motor, for enclosing he guide gear and the gear module, the gear module being rotatably disposed within the rotating gear of the rotator.

3. The foldable wireless terminal of claim 2, wherein the guide gear and the module housing are fixed to a bracket mounted on the driving motor.

4. The foldable wireless terminal of claim 3, wherein the module housing is configured to mount to the bracket in a snap-fit structure.

5. The foldable wireless terminal of claim 2, wherein the rotating gear and the hinge shaft of the rotator are integrally formed of plastic by injection molding.

6. The foldable wireless terminal of claim 1, wherein the hinge cam has a pair of peak portions and a valley portion at the center thereof and the hinge shaft has a protrusion to be fit in the valley portion of the hinge cam.

7. The foldable wireless terminal of claim 6, wherein in an automatic mode, the protrusion of the hinge shaft is caught between the peak portions of the hinge cam to rotate the hinge cam together with the hinge shaft, and in a manual mode, the peak portions of the hinge cam push the protrusion of the hinge shaft to retreat the deceleration module axially.

8. The foldable wireless terminal of claim 7, wherein in order to move the deceleration module axially within the hinge arm, a protrusion is formed on an outer circumferential surface of the module housing of the deceleration module and a guide slit is formed on the inner circumferential surface of the hinge arm, for guiding the protrusion axially.

9. The foldable wireless terminal of claim 1, further comprising a hollow spacer inserted into the hinge arm for supporting one end of the elastic member.

10. The foldable wireless terminal of claim 1, wherein the elastic member is a coil spring.

11. A sub-body opening/closing device for a foldable radiotelephone having a main body and a sub-body, the opening/closing device being usable for automatically or manually opening or closing the sub-body with respect to the main body of the radiotelephone, comprising:
a driving motor;
a deceleration module for reducing the rotation speed of the driving motor;
a hinge shaft operatively connected with the deceleration module and including a male cam surface at a distal end thereof;
a hinge cam including one end having a female cam surface configured to match the male cam surface of the hinge shaft, and an other end secured to one of the main body or the sub-body; and
an elastic member for biasing the hinge shaft toward the hinge cam and thereby to transfer the rotation power of the driving motor to the hinge cam in an automatic opening/closing mode.

12. The sub-body opening/closing device of claim 11, wherein the hinge shaft is subject to axial retraction from the hinge cam to enable opening or closing of the sub-body in a manual opening/closing mode.

13. The sub-body opening/closing device of claim 11, wherein the deceleration module includes a gear module having at least two gears.

14. The sub-body opening/closing device of claim 13, wherein the deceleration module further includes a rotator operatively connected to the gear module.

15. The sub-body opening/closing device of claim 14, wherein the rotator includes a rotating gear having gear teeth along the inner circumferential surface thereof for engaging with the gears of the gear module.

16. The sub-body opening/closing device of claim 15, wherein the hinge shaft and the rotator are formed integrally of plastic material.

17. The sub-body opening/closing device of claim 11, further including a hollow hinge arm for enclosing the driving motor, the deceleration module and the hinge shaft therein.
